(19) United States
(12) Patent Application Publication
(10) Pub. No.: US 2013/0158196 A1
(43) Pub. Date: Jun. 20, 2013

(54) ALIPHATIC-AROMATIC COPOLYETHERESTERS

(71) Applicant: Mark F. Teasley, Landenberg, PA (US)

(72) Inventor: Mark F. Teasley, Landenberg, PA (US)

(73) Assignee: E. I. DU PONT DE NEMOURS AND COMPANY, Wilmington, DE (US)

(21) Appl. No.: 13/329,526

(22) Filed: Dec. 19, 2011

(51) Int. Cl. C08L 3/00; C08L 67/04; C08L 93/00; C08G 63/672; C08L 67/03

(52) U.S. Cl. 525/54.31; 528/301; 525/418; 525/54.4; 525/450

(57) ABSTRACT

Provided are aliphatic-aromatic copolyetheresters that can exhibit biodegradation and improved physical properties. The copolyetheresters can be blended with other polymeric materials, and are useful for making a variety of shaped articles.

### FIELD OF THE INVENTION

This invention relates to aliphatic-aromatic copolyetheresters that can exhibit biodegradation and improved physical properties. The invention also relates to articles and blends using the copolyetheresters.

### BACKGROUND

As the world population increases, resources become scarcer and societal habits have a greater impact on the environment. Consequently, there is growing resistance to the use of petroleum as a material feedstock and a movement into sustainability in which the polymeric materials that we use would be made from renewable sources using renewable energy and would biodegrade harmlessly after they serve their purpose. These trends have manifested themselves in a search for monomers that are derived from biological sources and that impart biodegradability on the polymers into which they are incorporated.

Previous efforts have focused on two broad areas, aliphatic polyesters and copolyesters, and aliphatic-aromatic copolyesters. Aliphatic polyesters are generally synthesized by reaction of a single diol with one or more linear aliphatic dicarboxylic acids. Despite showing significant biodegradation potential, their thermal properties are often insufficient for real world applications. Specifically, the homopolymers often have low melt temperatures and the copolymers often have low crystallinity or are amorphous.

Because of these shortcomings, a greater body of work is focused on aliphatic-aromatic copolyesters. U.S. Pat. No. 6,120,895 discloses certain biodegradable compositions based on a polyester comprising an aliphatic or cycloaliphatic dicarboxylic acid or ester component and an aromatic acid or ester component, and a mixture of cyanurates or other compounds capable of reacting with the end groups of the polyester. U.S. Patent Publication No. 2005/0208291 discloses biodegradable aliphatic-aromatic copolyester films containing filler particles.

Herein are disclosed aliphatic-aromatic copolyetheresters that comprise such monomers that can be obtained from renewable sources and that can be biodegradable. These compositions provide films that show good physical properties relative to those attributed to aliphatic-aromatic copolyesters. At the same time, these compositions provide thermal and biodegradation properties that make them particularly useful for flexible films applications.

### SUMMARY OF THE INVENTION

One aspect of the present invention is an aliphatic-aromatic copolyetherester consisting essentially of:

I. a dicarboxylic acid component consisting essentially of, based on 100 mole percent total dicarboxylic acid component:
a. about 100 to about 40 mole percent of a terephthalic acid component;
b. about 0 to about 60 mole percent of a linear aliphatic dicarboxylic acid component; and
c. optionally about 2 to about 60 mole percent of a non-linear dicarboxylic acid component;

II. a glycol component consisting essentially of, based on 100 mole percent total glycol component:
a. about 99.5 to about 30 mole percent of a linear glycol component; and
b. about 0.5 to about 70 mole percent of a polyalkylene ether glycol component.

Other aspects of the invention include blends of the aliphatic-aromatic copolyetheresters with other polymeric materials, including natural substances, and shaped articles comprising the aliphatic-aromatic copolyetheresters and blends thereof.

### DETAILED DESCRIPTION

Herein are described aliphatic-aromatic copolyetheresters that can be processed into shaped articles including films. The copolyetheresters are typically semicrystalline and biodegradable, and the films are typically compostable. The copolyetheresters are prepared via the polymerization of linear aliphatic diols with terephthalic acid, linear aliphatic dicarboxylic acids, and polyalkylene ether glycols with optional non-linear dicarboxylic acids as comonomers to improve their physical properties. The terms “diol” and “glycol” are used interchangeably to refer to general compositions of a primary, secondary, or tertiary alcohol containing two hydroxyl groups. The term “non-linear dicarboxylic acids” is intended to include all branched, alicyclic, or non-terephthalate aromatic dicarboxylic acids as disclosed in CL4828, CL4862, and CL4863 to improve tear strength in films. The term “semicrystalline” is intended to indicate that some fraction of the polymer chains of the aromatic-aliphatic copolyetheresters reside in a crystalline phase with the remaining fraction of the polymer chains residing in a non-ordered amorphous phase. The crystalline phase is characterized by a peak melting temperature, Tm, and the amorphous phase by a glass transition temperature, Tg, which can be measured using Differential Scanning calorimetry (DSC). Note that ester, lactone, anhydride, or ester-forming derivatives of the various dicarboxylic acids may be used in the polymerizations in lieu of the dicarboxylic acids themselves.

The dicarboxylic acid component consists essentially of about 100 to about 40 mole percent of a terephthalic acid component, about 0 to about 60 mole percent of an linear aliphatic dicarboxylic acid component, and optionally about 2 to about 60 mole percent of a non-linear dicarboxylic acid component all of which are based on 100 mole percent of total dicarboxylic acid component. Additionally, the glycol component consists essentially of about 99.5 to about 30 mole percent of a linear glycol component and about 0.5 to about 70 mole percent of a polyalkylene ether glycol component all of which are based on 100 mole percent total glycol component. With aliphatic-aromatic copolyetheresters that include the optional non-linear dicarboxylic acid component to enhance the physical properties of films made therefrom, such as tear strength, the mole percent for the non-linear dicarboxylic acid component as defined above is preferably at least about 2 mole percent.

Terephthalic acid components that are useful in the aliphatic-aromatic copolyetheresters include terephthalic acid, bis(glycolates) of terephthalic acid, and lower alkyl esters of terephthalic acid having from 8 to 20 carbon atoms. Specific examples of desirable terephthalic acid components include terephthalic acid, dimethyl terephthalate, bis(2-hydroxyethyl)terephthalate, bis(3-hydroxypropyl) terephthalate, bis(4-hydroxybutyl)terephthalate.

Linear aliphatic dicarboxylic acid components that are useful in the aliphatic-aromatic copolyetheresters include unsubstituted and methyl-substituted aliphatic dicarboxylic acids and their lower alkyl esters having from 2 to 36 carbon atoms. Specific examples of desirable linear aliphatic dicarboxylic acid components include, oxalic acid, dimethyl oxalate, malonic acid, dimethyl malonate, succinic acid, dimethyl succinate, glutaric acid, dimethyl glutarate, 3,3-dimethylglutaric acid, adipic acid, dimethyl adipate, pimelic acid, suberic acid, azelaic acid, dimethyl azelate, sebacic acid, dimethyl sebacate, undecanedioic acid, 1,10-decanedicarboxylic acid, 1,11-undecanedicarboxylic acid (brassylic acid), 1,12-dodecanedicarboxylic acid, hexadecanedioic acid, docosanedioic acid, tetracosanedioic acid, and mixtures derived therefrom. In some preferred embodiments, the linear aliphatic dicarboxylic acid component can be derived from a renewable biological source, in particular succinic acid, glutaric acid, azelaic acid, sebacic acid, and brassylic acid. A linear aliphatic dicarboxylic acid component that can be derived from a renewable biological source is succinic acid. However, both renewably-sourced and conventionally-sourced linear aliphatic dicarboxylic acids or derivatives can be used, including mixtures thereof.

Linear glycol components that typically find use in the embodiments disclosed herein include unsubstituted and methyl-substituted aliphatic diols of 2 to 10 carbon atoms. Examples include 1,2-ethanediol, 1,2-propanediol, 1,3-propanediol, 2,2-dimethyl-1,3-propanediol, and 1,4-butanediol. In some preferred embodiments, the linear glycol components can be derived from a renewable biological source, in particular 1,3-propanediol and 1,4-butanediol. A linear glycol component that can be derived from a renewable biological source is 1,4-butanediol.

The polyalkylene ether glycol components are added to the polymerizations as monomers, but typically a small fraction of dialkylene glycol component is also generated in situ by dimerization of the linear glycol components under the conditions required for polymerization. Methods to control the dimerization of the linear glycols include monomer selection such as choice between dicarboxylic acids and their derivatives or inclusion of sulfonated monomers, catalyst selection, catalyst amount, inclusion of strong protonic acids, addition of basic compounds such as tetramethylammonium hydroxide or sodium acetate, and other process conditions such as temperatures and residence times. Generally, the dialkylene glycol component is present from about 0 to 4 mole based on 100 mole percent total glycol component. Typically, the dialkylene glycol component is present in less than about 0.5 mole percent based on 100 mole percent total glycol component.

Polyalkylene ether glycol components that typically find use in the embodiments disclosed herein are based on unsubstituted and methyl-substituted aliphatic repeat units containing 2 to 10 carbon atoms and generally have a molecular weight in the range of about 100 daltons to about 4000 daltons. Examples include poly(ethylene ether) glycol, poly(1,2-propylene ether) glycol, poly(trimethylene ether) glycol, poly(tetramethylene ether) glycol (polytetrahydrofuran), poly(pentmethylene ether) glycol, poly(hexamethylene ether) glycol, poly(heptamethylene ether) glycol, and poly(ethylene glycol)-block-poly(propylene glycol)-block-poly(ethylene glycol). Preferably, the polyalkylene ether glycol components are derived from a renewable biological source, in particular poly(trimethylene ether) glycol and poly(tetramethylene ether) glycol. Typically, the polyalkylene ether glycol component is poly(tetramethylene ether) glycol. Typically, the polyalkylene ether glycol component has a molecular weight in the range of about 1000 daltons to about 2000 daltons for the embodiments containing a linear aliphatic dicarboxylic acid in order to obtain copolyetheresters with glass transition temperatures in the range of about −60° C. to about −20° C. and that provide films with Young's modulus of about 30 MPa to about 120 MPa. Alternatively, the polyalkylene ether glycol component has a molecular weight in the range of about 100 daltons to about 1000 daltons, typically about 200 daltons to about 400 daltons, for the embodiments that omit a linear aliphatic dicarboxylic acid in order to obtain copolyetheresters with glass transition temperatures in the range of about −60° C. to about −20° C. and that provide films with Young's modulus of about 30 MPa to about 120 MPa.

The optional non-linear dicarboxylic acid components that are useful in the aliphatic-aromatic copolyetheresters include branched, alicyclic, and non-terephthalate aromatic dicarboxylic acids and their bis(glycolates), lower alkyl esters, and other derivatives.

The term “branched dicarboxylic acids” is intended to include all aliphatic, alicyclic, or aromatic dicarboxylic acids that are substituted with aliphatic, alicyclic, or aromatic side-chain groups containing at least 2 carbon atoms and optionally containing oxygen atoms and their lower alkyl esters having from 8 to 48 carbon atoms. The aliphatic side-chain itself may be a linear or branched aliphatic group, and the alicyclic and aromatic side-chains may be additionally substituted with these groups or methyl groups. The optional oxygen atoms can be in the form of ethers or polyethers. The side-chain groups are not intended to include long-chain branches that contain more than about 400 carbon atoms, which are generated during the course of polymerization by tri- and polyfunctional comonomers containing carboxylic acid and hydroxyl groups. Also, the side-chain groups are not intended to include ionic substituents, such as anionic sulfonate and phosphate groups. Examples of desirable branched aliphatic dicarboxylic acid components include branched derivatives of the linear aliphatic dicarboxylic acids and dimers of unsaturated aliphatic carboxylic acids derived from renewable biological sources. Examples of desirable branched alicyclic dicarboxylic acid components include substituted derivatives of 1,4-cyclohexanedicarboxylates, 1,3-cyclohexanedicarboxylates, and 1,2-cyclohexanedicarboxylates. Examples of desirable branched aromatic dicarboxylic acid components include substituted derivatives of terephthalates, isophthalates, phthalates, naphthalates and bibenzoates.

Specific examples of desirable branched dicarboxylic acid components include 3-hexylglutaric acid, 3-phenylglutaric acid, 3,3-tetramethyleneglutaric acid, 3,3-tetramethyleneglutaric anhydride, 3-methyl-3-ethylglutaric acid, 3-tert-butyladipic acid, 3-hexyladipic acid, 3-octyladipic acid, 3-(2,4,4-trimethylpentyl)-hexanedioic acid, diethyl dibutylmalonate, 1,1-cyclohexanediacetic acid, cyclohexylsuccinic acid, 5-tert-butylisophthalic acid, 5-hexyloxyisophthalic acid, 5-octadecyloxyisophthalic acid, 5-phenoxyisophthalic acid, 2-phenoxyterephthalic acid, 2,5-biphenyldicarboxylic acid, 3,5-biphenyldicarboxylic acid, 5-tert-butyl-1,3-cyclohexanedicarboxylic acid, 5-tert-pentyl-1,3-cyclohexanedicarboxylic acid, 5-cyclohexyl-1,3-cyclohexanedicarboxylic acid, 2-cyclohexyl-1,4-cyclohexanedicarboxylic acid, fatty acid dimers, hydrogenated fatty acid dimers, and diabietic acids. Preferably, the branched dicarboxylic acid component is derived from a renewable biological source, in particular fatty acid dimers and hydrogenated fatty acid dimers. However, essentially any branched dicarboxylic acid or derivative known can be used, or as a mixture of two or more thereof.

Alicyclic dicarboxylic acids that are useful in the aliphatic-aromatic copolyetheresters include unsubstituted and methyl-substituted alicyclic dicarboxylic acids and their lower alkyl esters having 5 to 36 carbon atoms. Specific examples include 1,4-cyclohexane dicarboxylic acid, 1,2-cyclohexane dicarboxylic acid, 1,3-cyclopentane dicarboxylic acid, and (±)-camphoric acid. Preferably, the alicyclic dicarboxylic acid component is derived from a renewable biological source, in particular (±)-camphoric acid. However, essentially any alicyclic dicarboxylic acid or derivative having 5 to 36 carbon atoms can be used, including mixtures thereof.

Aromatic dicarboxylic acid components useful in the aliphatic-aromatic copolyetheresters include unsubstituted and methyl-substituted aromatic dicarboxylic acids, bis(glycolates) of aromatic dicarboxylic acids, and lower alkyl esters of aromatic dicarboxylic acids having from 8 carbons to 20 carbons. Examples of desirable dicarboxylic acid components include those derived from phthalates, isophthalates, naphthalates and bibenzoates. Specific examples of desirable aromatic dicarboxylic acid component include phthalic acid, dimethyl phthalate, phthalic anhydride, bis(2-hydroxyethyl)phthalate, bis(3-hydroxypropyl)phthalate, bis(4-hydroxybutyl)phthalate, isophthalic acid, dimethyl isophthalate, bis(2-hydroxyethyl)isophthalate, bis(3-hydroxypropyl)isophthalate, bis(4-hydroxybutyl)isophthalate, 2,6-naphthalene dicarboxylic acid, dimethyl-2,6-naphthalate, 2,7-naphthalenedicarboxylic acid, dimethyl-2,7-naphthalate, 1,8-naphthalene dicarboxylic acid, dimethyl 1,8-naphthalenedicarboxylate, 1,8-naphthalic anhydride, 3,4′-diphenyl ether dicarboxylic acid, dimethyl-3,4′-diphenyl ether dicarboxylate, 4,4′-diphenyl ether dicarboxylic acid, dimethyl-4,4′-diphenyl ether dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylenaphthalenezoic acid), dimethyl-4,4′-methylenebis(benzoate), biphenyl-4,4′-dicarboxylic acid and mixtures derived therefrom. Typically, the aromatic dicarboxylic acid component is derived from phthalic anhydride or phthalic acid. However, any aromatic dicarboxylic acid or derivative known in the art can be used for the aromatic dicarboxylic acid, including mixtures thereof. The monomers are not intended to include ionic substituents, such as anionic sulfonate and phosphate groups.

In a typical embodiment of the aliphatic-aromatic copolyetherester, the dicarboxylic acid component consists essentially of about 70 to about 40 mole percent of the terephthalic acid component, about 30 to about 60 mole percent of the linear aliphatic dicarboxylic acid component, and optionally about 2 to about 60 mole percent of the non-linear dicarboxylic acid component. In addition, the glycol component consists essentially of about 99.5 to about 70 mole percent of the linear glycol component and about 0.5 to about 30 mole percent of the polyalkylene ether glycol component.

In a more typical embodiment of the aliphatic-aromatic copolyester, the optional non-linear dicarboxylic acid component is omitted from the composition. The dicarboxylic acid component consists essentially of about 56 to about 46 mole percent of the terephthalic acid component and about 44 to about 54 mole percent of the linear aliphatic dicarboxylic acid component. The glycol component consists essentially of about 99 to about 96 mole percent of the linear glycol component and about 1 to about 4 mole percent of the polyalkylene ether glycol component having a molecular weight in the range of about 1000 to about 2000 daltons.

In a yet more typical embodiment of the aliphatic-aromatic copolyester, the dicarboxylic acid component consists essentially of about 50 to about 48 mole percent of the terephthalic acid component and about 50 to about 52 mole percent of the linear aliphatic dicarboxylic acid component. The glycol component consists essentially of about 99 to about 96 mole percent of the linear glycol component and about 1 to about 4 mole percent of the polyalkylene ether glycol component having a molecular weight in the range of about 1000 to about 2000 daltons.

In a typical alternative embodiment of the aliphatic-aromatic copolyester, the linear aliphatic dicarboxylic acid component and optional non-linear dicarboxylic acid component are omitted from the composition. The dicarboxylic acid component consists essentially of about 100 mole percent of the terephthalic acid component. The glycol component consists essentially of about 50 to about 30 mole percent of the linear glycol component and about 50 to about 70 mole percent of the polyalkylene ether glycol component having a molecular weight in the range of about 100 to about 1000 daltons.

In a more typical alternative embodiment of the aliphatic-aromatic copolyester, the dicarboxylic acid component consists essentially of about 100 mole percent of the terephthalic acid component. The glycol component consists essentially of about 44 to about 35 mole percent of the linear glycol component and about 56 to about 65 mole percent of the polyalkylene ether glycol component having a molecular weight in the range of about 200 to about 400 daltons.

In a yet more typical alternative embodiment of the aliphatic-aromatic copolyester, the dicarboxylic acid component consists essentially of about 100 mole percent of the terephthalic acid component. The glycol component consists essentially of about 42 to about 38 mole percent of the linear glycol component and about 58 to about 62 mole percent of the polyalkylene ether glycol component having a molecular weight in the range of about 200 to about 400 daltons.

In general, the aliphatic-aromatic copolyetheresters can be polymerized from the disclosed monomers by any process known for the preparation of polyesters. Such processes can be operated in either a batch, semi-batch, or in a continuous mode using suitable reactor configurations. The specific batch reactor process used to prepare the polymers disclosed in the embodiments herein is equipped with a means for heating the reaction to 260° C., a fractionation column for distilling off volatile liquids, an efficient stirrer capable of stirring a high viscosity melt, a means for blanketing the reactor contents with nitrogen, and a vacuum system capable of achieving a vacuum of less than 1 Torr.

This batch process is generally carried out in two steps: ester interchange and polycondensation. In the first step, ester interchange, dicarboxylic acid monomers or their derivatives are reacted with a glycol in the presence of an ester interchange catalyst. This results in the formation of alcohol and/or water, which distills out of the reaction vessel, and glycolate adducts of the dicarboxylic acids. The exact amount of monomers charged to the reactor is readily determined by a skilled practitioner depending on the amount of polymer desired and its composition. It is advantageous to use excess glycol in the ester interchange step with the excess distilled off during the polycondensation step. A glycol excess of 10 to 100% is commonly used. Catalysts are generally known in the art, and preferred catalysts for this process are titanium alkoxides. The amount of catalyst used is usually 20 to 200 parts titanium per million parts polymer. The combined monomers are heated gradually with mixing to a temperature in the range of 200 to 250° C. Depending on the reactor and the monomers used, the reactor may be heated directly to 250° C., or there may be a hold at a temperature in the range of 200 to 230° C. to allow the ester interchange to occur and the volatile products to distill out without loss of the excess glycol. The ester interchange step is usually completed at a temperature ranging from 240 to 260° C. The completion of the interchange step is determined from the amount of alcohol and/or water collected and by falling temperatures at the top of the distillation column. The polyalkylene ether glycol is typically added at the end of the ester interchange step and before beginning the polycondensation step.

The polycondensation step is carried out at 240 to 260° C. under vacuum to distill out the excess glycol. It is preferred to apply the vacuum gradually to avoid bumping of the reactor contents. Stirring is continued under a full vacuum of less than 1 Torr until the desired melt viscosity is reached. A practitioner experienced with the reactor is able to determine if the polymer has reached the desired melt viscosity from the torque on the stirrer motor. Optionally, a chain extender can be added at the end of the polycondensation step to boost the melt viscosity into the desired range after releasing the vacuum to nitrogen.

It is generally preferred that the aliphatic-aromatic copolyetheresters have sufficiently high molecular weights to provide suitable melt viscosity for processing into shaped articles, such as films, and useful levels of mechanical properties in the articles. The copolyetheresters are particularly suited for blends of polymeric materials that will be used to make melt blown films. A sufficiently high molecular weight provides the copolyetheresters with useful levels of mechanical properties, such as flexibility, toughness, tear resistance, and impact resistance, as well as relatively high degrees of elongation in films of both the copolyetheresters and their blends. Generally, weight average molecular weights (Mw) from about 10,000 g/mol to about 150,000 g/mol are useful. More typical are Mw from about 20,000 g/mol to about 100,000 g/mol. Most typical are Mw from about 30,000 g/mol to about 80,000 g/mol. In practical terms, molecular weights are often correlated to solution viscosities, such as intrinsic or inherent viscosity. While the exact correlation depends on the composition of a given copolymer, the molecular weights above generally correspond to intrinsic viscosity (IV) values from about 0.5 dL/g to about 2.0 dL/g. More typical are IV values from about 0.8 dL/g to about 1.6 dL/g. Most typical are IV values from about 1.0 dL/g to about 1.5 dL/g. Although the copolyetheresters prepared by the processes disclosed herein reach satisfactory molecular weights, it can be expedient to use chain extenders to rapidly increase the molecular weights and minimize the thermal history of the copolyetheresters while reducing the temperature and contact time of the ester interchange and polycondensation steps. Suitable chain extenders include diisocyanates, polyisocyanates, dianhydrides, diepoxides, polyepoxides, bis-oxazolines, carbodiimides, and divinyl ethers, which can be added at the end of the polycondensation step, during processing on mechanical extrusion equipment, or during processing of the copolyetheresters into desired shaped articles. Specific examples of desirable chain extenders include hexamethylene diisocyanate, methylene bis(4-phenylisocyanate), 1,3-bis(isocyanatomethyl)cyclohexane, and pyromellitic dianhydride. Such chain extenders are typically used at 0.1 to 2 weight percent with respect to the copolyetheresters.

Alternatively, the melt viscosity can be increased by incorporating a branching agent into the copolyetheresters during polymerization to introduce long-chain branches that contain more than about 400 carbon atoms. Suitable branching agents include trifunctional and polyfunctional compounds containing carboxylic acid functions, hydroxy functions, or mixtures thereof. Specific examples of desirable branching agents include 1,2,4-benzenetricarboxylic acid, (trimellitic acid), trimethyl-1,2,4-benzenetricarboxylate, 1,2,4-benzenetricarboxylic anhydride, (trimellitic anhydride), 1,3,5-benzenetricarboxylic acid (trimesic acid), 1,2,4,5-benzenetetracarboxylic acid (pyromellitic acid), 1,2,4,5-benzenetetracarboxylic dianhydride (pyromellitic dianhydride), 3,3′,4,4′-benzophenonetetracarboxylic dianhydride, 1,4,5,8-naphthalenetetracarboxylic dianhydride, 1,3,5-cyclohexanetricarboxylic acid, pentaerythritol, glycerol, 2-(hydroxymethyl)-1,3-propanediol, 1,1,1-tris(hydroxymethyl)propane, 2,2-bis(hydroxymethyl)propionic acid, and mixtures derived therefrom. Such branching agents are typically used at 0.01 to 0.5 mole percent with respect to the dicarboxylic acid component or the glycol component as dictated by the majority functional group of the branching agent.

Additionally, the thermal behavior of the copolyetheresters can be adjusted to an extent by incorporating nucleating agents during polymerization or processing of the copolyetheresters to accelerate their crystallization rates and provide a more uniform distribution of crystallites throughout the bulk of the polymer. In such manner, the processing of the copolyetheresters can be improved by maintaining a more uniform and consistent thermal quenching of the molten polymer potentially leading to improvement in the mechanical properties of the shaped articles. Particularly suitable nucleating agents include sodium salts of carboxylic acids and polymeric ionomers partially or fully neutralized with sodium cations. If incorporated during polymerization, lower molecular weight sodium salts are typically used and can be added with the monomers or later in the process, such as after completion of the ester interchange step and before or during the polycondensation step. If compounded into finished copolyester, higher molecular weight sodium salts and the polymeric ionomers are typically used and can be added during mechanical extrusion with sufficient mixing. Specific examples of desirable nucleating agents include sodium acetate, sodium acetate trihydrate, sodium formate, sodium bicarbonate, sodium benzoate, monosodium terephthalate, sodium stearate, sodium erucate, sodium montanate (Licomont® NaV 101, Clariant), Surlyn® sodium ionomers (ethylene-methacrylic acid sodium ionomers, DuPont™) and AClyn® 285 (low molecular weight ethylene-acrylic acid sodium ionomer, Honeywell International, Inc.). Such nucleating agents are typically used at levels that deliver 10 to 1000 ppm sodium with respect to the copolyetheresters.

The aliphatic-aromatic copolyetheresters can be blended with other polymeric materials. Such polymeric materials can be biodegradable or not biodegradable, can be derived from renewable biological and non-renewable petrochemical sources, and can be used in their natural state or modified natural state, or can be synthesized from any of these sources.

Examples of biodegradable synthetic polymeric materials suitable for blending with the aliphatic-aromatic copolyetheresters include poly(hydroxyalkanoates), polycarbonates, poly(caprolactone), polylactide, poly(lactic acid), aliphatic polyesters, aliphatic-aromatic copolyesters, aliphatic-aromatic copolyetheresters, aliphatic-aromatic copolyamideesters, sulfonated aliphatic-aromatic copolyesters, sulfonated aliphatic-aromatic copolyetheresters, sulfonated aliphatic-aromatic copolyamideesters, and copolymers and mixtures derived therefrom. Polylactide or polylatic acid is a particular example of a biodegradable synthetic polymeric material that is derived from renewable biological sources. Specific examples of blendable biodegradable materials include the Biomax® sulfonated aliphatic-aromatic copolyesters of the DuPont Company, the Eastar Bio® aliphatic-aromatic copolyesters of the Eastman Chemical Company, the Ecoflex® aliphatic-aromatic copolyesters of the BASF corporation, poly(1,4-butylene terephthalate-co-adipate, the EnPol® polyesters of the IRe Chemical Company, poly(1,4-butylene succinate), the Bionolle® polyesters of the Showa High Polymer Company, poly(ethylene succinate), poly(1,4-butylene adipate-co-succinate), poly(1,4-butylene adipate), poly(amide esters), the Bak® poly(amide esters) of the Bayer Company, poly(ethylene carbonate), poly(hydroxybutyrate), poly(hydroxyvalerate), poly(hydroxybutyrate-co-hydroxyvalerate), the Biopol® poly(hydroxyalkanoates) of the Monsanto Company, poly(lactide-co-glycolide-co-caprolactone), the Tone® poly(caprolactone) of the Union Carbide Company, the Ingeo™ poly(lactide) of NatureWorks LLC, and mixtures derived therefrom. Essentially any biodegradable material can be blended with the aliphatic-aromatic copolyetheresters.

Examples of nonbiodegradable synthetic polymeric materials suitable for blending with the aliphatic-aromatic copolyetheresters include polyethylene, high density polyethylene, low density polyethylene, linear low density polyethylene, ultralow density polyethylene, polyolefins, ply(ethylene-co-glycidylmethacrylate), poly(ethylene-co-methyl (meth) acrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), poly(ethylene-co-(meth) acrylic acid), metal salts of poly(ethylene-co-(meth)acrylic acid), poly((meth)acrylates), such as poly(methyl methacrylate), poly(ethyl methacrylate), poly(ethylene-co-carbon monoxide), poly(vinyl acetate), poly(ethylene-co-vinyl acetate), poly(vinyl alcohol), poly(ethylene-co-vinyl alcohol), polypropylene, polybutylene, polyesters, poly(ethylene terephthalate), poly(1,3-propyl terephthalate), poly(1,4-butylene terephthalate), poly(ethylene-co-1,4-cyclohexanedimethanol terephthalate), poly(vinyl chloride), poly(vinylidene chloride), polystyrene, syndiotactic polystyrene, poly(4-hydroxystyrene), novalacs, poly(cresols), polyamides, nylon, nylon 6, nylon 46, nylon 66, nylon 612, polycarbonates, poly(bisphenol A carbonate), polysulfides, poly(phenylene sulfide), polyethers, poly(2,6-dimethylphenylene oxide), polysulfones, and copolymers thereof and mixtures derived therefrom.

Examples of biodegradable renewably-sourced natural polymeric materials suitable for blending with the aliphatic-aromatic copolyetheresters include starch, starch derivatives, modified starch, thermoplastic starch, cationic starch, anionic starch, starch esters, such as starch acetate, starch hydroxyethyl ether, alkyl starches, dextrins, amine starches, phosphate starches, dialdehyde starches, cellulose, cellulose derivatives, modified cellulose, cellulose esters, such as cellulose acetate, cellulose diacetate, cellulose propionate, cellulose butyrate, cellulose valerate, cellulose triacetate, cellulose tripropionate, cellulose tributyrate, and cellulose mixed esters, such as cellulose acetate propionate and cellulose acetate butyrate, cellulose ethers, such as methylhydroxyethylcellulose, hydroxymethylethylcellulose, carboxymethylcellulose, methyl cellulose, ethylcellulose, hydroxyethylcellulose, and hydroxyethylpropylcellulose, polysaccharides, alginic acid, alginates, phycocolloids, agar, gum arabic, guar gum, acacia gum, carrageenan gum, furcellaran gum, ghatti gum, psyllium gum, quince gum, tamarind gum, locust bean gum, gum karaya, xanthan gum, gum tragacanth, proteins, prolamine, collagen and derivatives thereof such as gelatin and glue, casein, sunflower protein, egg protein, soybean protein, vegetable gelatins, gluten, and mixtures derived therefrom. Thermoplastic starch can be produced, for example, as disclosed within U.S. Pat. No. 5,362,777. Any natural polymeric material known can be blended with the aliphatic-aromatic copolyetheresters.

The aliphatic-aromatic copolyetheresters and blends formed therefrom can be used to make a wide variety of shaped articles. Shaped articles that can be made from the aliphatic-aromatic copolyetheresters include films, sheets, fibers, filaments, bags, melt blown containers, molded parts such as cutlery, coatings, polymeric melt extrusion coatings on substrates, polymeric solution coatings onto substrates, laminates, and bicomponent, multi-layer, and foamed varieties of such shaped articles. The aliphatic-aromatic copolyetheresters are useful in making any shaped article that can be made from a polymer. The aliphatic-aromatic copolyetheresters can be formed into such shaped articles using any known process therefore, including thermoplastic processes such as compression molding, thermoforming, extrusion, coextrusion, injection molding, blow molding, melt spinning, film casting, film blowing, biaxial film orientation, lamination, foaming using gases or chemical foaming agents, or any suitable combination thereof to prepare the desired shaped article.

Shaped articles, particularly those that find use in packaging, including films, bags, containers, cups, and trays among others, are typically desired to be compostable. The current standards for compostable packaging and packaging materials are described in ASTM D6400-04 and EN 13432:2000. As the more stringent standard, EN 13432 is more pertinent for the qualification of new compostable packaging materials. To qualify as compostable, the packaging typically disintegrates in 3 months under the conditions of an industrial composting facility and biodegrade to carbon dioxide at the level of 90% in 6 months without any negative impact due to toxicity on the composting process or on plant growth using the resulting compost. In this regard, the aliphatic-aromatic copolyetheresters disclosed herein can be said to be biodegradable when shaped articles made therefrom and used as packaging materials, such as films, are shown to be compostable. In a typical embodiment, the shaped articles comprise films that are compostable at thicknesses of up to 20 microns, more typically up to 70 microns, in some embodiments up to 120 microns, and in yet other embodiments greater than 120 microns.

The aliphatic-aromatic copolyetheresters and blends formed therefrom are particularly well suited for the extrusion and blowing of compostable films with high tear strength. Films are commonly tested for tear strength according to the Elmendorf method as described in ASTM D1922-09. In typical applications for films, such as bags, the tear strength is desirably at least 1000 g/mm, but higher values, such as those greater than 4000 g/mm, are desirable as they allow a thinner gauge to be used. Values greater than 8000 g/mm, 12,000 g/mm, or even 16,000 g/mm can provide additional benefits when balanced with other properties desired for a given application. The aliphatic-aromatic copolyetheresters provide films that can attain these levels of tear strength. Further enhancement of tear strength is possible by incorporating the optional non-linear dicarboxylic acid component into the copolyetheresters or by blending the copolyetheresters with other materials, particularly polymeric materials such as starch, to give values greater than 10,000 g/mm, 15,000 g/mm, or even 20,000 g/mm.

The aliphatic-aromatic copolyetheresters and blends thereof, and the shaped articles formed therefrom can contain any known additive used in polyesters as a processing aid or for end-use properties. The additives are preferably nontoxic, biodegradable, and derived from renewable biological sources. Such additives include compatibilizers for the polymer blend components, antioxidants, thermal and UV stabilizers, flame retardants, plasticizers, flow enhancers, slip agents, rheology modifiers, lubricants, tougheners, pigments, antiblocking agents, inorganic and organic fillers, such as silica, clay, talc, chalk, titanium dioxide, carbon black, wood flour, keratin, chitin, refined feathers and reinforcing fibers, such as glass fibers and natural fibers like paper, jute and hemp.

### Test Methods

The intrinsic viscosity (IV) of the copolyetheresters was determined using a Viscotek Forced Flow Viscometer (FFV) Model Y-501C. The polymers were dissolved in 50/50 weight % trifluoroacetic acid/methylene chloride at a 0.4% (weight/volume) concentration at 19° C. A sample size of 0.1000 g polymer was typically used to prepare 25 mL of solution. The intrinsic viscosity values reported by this method were equivalent to values determined using Goodyear Method R-103B “Determination of Intrinsic Viscosity in 50/50 [by weight] Trifluoroacetic Acid/Dichloromethane”.

The compositions of the copolyetheresters were determined by ¹H Nuclear Magnetic Resonance Spectroscopy (NMR). Pellets or flakes of each polymer were dissolved in 1,1,2,2-tetrachloroethane-d₂. The solution was transferred into a 5 mm NMR tube and the spectrum was obtained at 30° C. on a Varian Inova or Bruker AVII 500 MHz Spectrometer. Mole-% composition of each sample was calculated from the integrations of appropriate areas of the spectrum.

Differential Scanning calorimetry (DSC) was performed on a TA Instruments (New Castle, Del.) Model Q1000 or Q2000 Thermal Analyzer under a nitrogen atmosphere. Samples were heated from −90 to 270° C. at 10° C./minute, cooled to −90° C. at 10° C./minute, and heated from −90 to 270° C. at 10° C./minute. The thermal transitions were determined from the cooling curve (Tc) and the second heating curve (Tg, Tcc, and Tm).

Films of the copolyetheresterswere compression molded into 4″×4″ squares by placing an approximately 2.25 gram sample of each polymer between Teflon®-coated aluminum foil sheets separated by a 3 to 5 mil stainless steel spacer. This assembly was placed between steel plates and inserted into a press set to a temperature approximately 50° C. above the melt temperature of the polymer, typically 170° C. Pressures of approximately 3000 lb and 15,000 lb were sequentially applied to the assembly and maintained for approximately 3 minutes each. The assembly was removed from the press and allowed to cool to room temperature. Separation of the aluminum foil sheets produced free polymer films that were approximately 5 mils thick. The films were tested for tensile properties according to ASTM D1708 at a strain rate of 500%/min unless specified, and for Elmendorf tear strength according to ASTM D1922. The reported values are the averages of at least five replicates.

### EXAMPLES

The copolyetheresters were synthesized on the laboratory scale to give theoretical yields of 100 g using the following general procedure with only minor variations in time and temperature. For each example in the tables below, a 250 mL three-neck glass flask was charged with the listed monomers. The flask was equipped with a Vigreux distillation head with graduated collection cylinder, a stainless steel stirrer with vacuum-tight PTFE bearing, and a gas inlet, and purged with a stream of nitrogen. The flask was charged with titanium(IV) butoxide (71 mg, 100 ppm Ti) then deaerated by stirring at 25 rpm and carefully cycling between vacuum (100 Torr) and nitrogen three times. The reaction mixture was heated to 165° C. with under nitrogen to melt the monomers then ramped to 230° C. with stirring at 100 rpm to begin the distillation of water. The column and then the flask were insulated to maintain a steady rate of distillation. When the distillation ceased at 230° C., the temperature was staged to 250° C. to continue the distillation. When near the theoretical amount of distillate was collected, or an excess due to the formation and co-distillation of tetrahydrofuran when using 1,4-butanediol, the flask was allowed to cool to room temperature under nitrogen.

The flask was charged with the polyalkylene ether glycol listed in the tables below for each example. For the examples in Table 4, 0.178 g sodium acetate trihydrate (300 ppm Na) was also charged to the flask. The graduated cylinder was exchanged for a collection flask, which was cooled with dry ice. The reaction flask was reheated to melt the oligomers, stirred at 100 rpm, and slowly placed under vacuum to control the distillation of excess diol. The polymer was stirred at 250° C. under full vacuum (less than 0.1 Torr) to continue the distillation of diol while reducing the stirring rate to accommodate the increase in melt viscosity as measured from the torque on the stirrer shaft. When the melt viscosity had leveled off, the vacuum was released to nitrogen. Optionally, the melt viscosity was further increased by slowly adding hexamethylene diisocyanate to chain extend the polymer then stirred until it had stabilized at a constant value. The flask was allowed to cool to room temperature. The polymer was isolated by breaking the flask and subjected to laboratory analysis as shown for each example listed in the tables below. The weight % of poly(alkylene ether) glycol and hexamethylene diisocyanate is the same as the value shown in the grams for each example since the theoretical yield of finished polymer is 100 g.

Abbreviations used in the examples and tables are as follows: 4G (1,4-butanediol), 3G (1,3-propanediol), TPA (terephthalic acid), DMT (dimethyl terephthalate), Suc (succinic acid), Seb (sebacic acid), PAEG (polyalkylene ether glycol), ID (identity), PTG (poly(tetramethylene ether)glycol), P3G (poly(trimethylene ether)glycol), TBT (Tyzor® TBT, titanium(IV) butoxide), HMDI (hexamethylene diisocyanate), T (terephthalate), YM (Young's Modulus), TS (tensile strength), E (elongation), Elm Tear (Elmendorf Tear Strength), rpm (revolutions per minute), ppm (parts per million).

Renewably sourced 1,3-propanediol (Bio-PDO™) was obtained from DuPont Tate & Lyle, Loudon, Tenn., USA. Renewably sourced poly(tetramethylene ether)glycol (PTG 1800) and Cerenol™ poly(trimethylene ether)glycols (P3G 250 and 650) were obtained from internal sources. Renewably sourced sebacic acid was obtained from NCeed Enterprises, Nazareth, Pa., USA. All other chemicals, reagents and materials, unless otherwise indicated, were obtained from Aldrich Chemical Company, Milwaukee, Wis., USA.

### Comparative Examples A and B

Two copolyetheresters were synthesized from 1,4-butanediol, terephthalic acid or dimethyl terephthalate, and sebacic acid as shown in Table 1 to demonstrate known copolyetheresters that can be used in biodegradable film applications. The copolyetheresters contain a small amount of dialkylene glycol that is produced during polymerization.

### Examples 1-7

A series of copolyetheresters were synthesized from 1,4-butanediol, terephthalic acid or dimethyl terephthalate, sebacic acid, and various bio-based polyalkylene ether glycols as shown in Table 1. Although good tensile strengths could be obtained, the Young's modulus was on the low end of the typical range for most biodegradable film applications.

### Example 8

The general procedure described above was carried out using dimethyl terephthalate (26.6 g), dimethyl sebacate (37.1 g), P3G 2000 (8.94 g, 11.2 wt % in the final polymer), 1,4-butanediol (47.6 g), and 47.5 mg titanium(IV) isopropoxide (100 ppm Ti), except that all of the reagents were added together before carrying out the esterification step and the initial temperature was 210° C. due to the distillation of methanol. The collected distillate measure 27 mL versus the theoretical amount of 24 mL due to the co-distillation of tetrahydrofuran. The polycondensation step was carried out directly without cooling to give a polymer with a Goodyear intrinsic viscosity with a value of 1.65 dL/g. Differential scanning calorimetry (DSC) showed a crystalline Tm of 121° C. (17 J/g) and a glass transition Tg of −46° C. ¹H NMR showed a polymer composition of 49.2 mole % 4G, 25.5 mole % T, 24.5 mole % Seb, and 0.77 mole % P3G 2000. Pressed films had Young's Modulus of 27 MPa, tensile strength of 12 MPa, and elongations of 1186%.

Compared to those of Table 1, this example had lower tensile strength and Young's modulus despite having higher intrinsic viscosity. This supports that the tetramethylene ether repeat unit of PTG 1800 is superior to the trimethylene ether repeat unit of P3G 2000 despite their similar molecular weights.

### Examples 9-19

A series of copolyetheresters were synthesized from 1,4-butanediol, terephthalic acid, succinic acid, and various bio-based polyalkylene ether glycols as shown in Table 2. In Examples 11 and 12, hexamethylene diisocyanate was used to rapidly chain extend the polymers to higher molecular weights. In all cases, excellent tensile properties were obtained that were more than sufficient for typical biodegradable film applications. Compared to those of Table 1, the examples of Table 2 show that succinic acid gives excellent tensile properties more consistently than sebacic acid.

### Example 20

A 1 L three-neck glass flask was charged with terephthalic acid (100.3 g), succinic acid (83.7 g), and 1,4-butanediol (208.7 g). The esterification step was carried out following the general procedure described above using 0.213 g titanium(IV) butoxide (100 ppm Ti). A total of 76 mL of distillate was collected versus the theoretical amount of 47 mL due to the co-distillation of tetrahydrofuran. After cooling the oligomers to room temperature, the flask was charged with PTG 1800 (47.3 g, 15.8 weight % in the final polymer). The polycondensation step was carried out at 250° C. under full vacuum until the melt viscosity began to level off. The vacuum was released to nitrogen and a sample of the polymer (A) was taken and quenched in liquid nitrogen. The flask was cooled to 210° C. and equipped with a septum. Hexamethylene diisocyanate (0.46 g) was added dropwise by syringe until the polymer balled up upon the stirrer, during which the temperature was allowed to rise to 240° C. The polymer was stirred until the polymer relaxed off the stirrer and the melt viscosity had stabilized. The flask was allowed to cool to room temperature. The polymer (B) was isolated by breaking the flask.

Samples A and B were measured for Goodyear intrinsic viscosity with a values of 1.05 and 1.19 dL/g. Differential scanning calorimetry (DSC) showed sample A and B had crystalline melting Tm of 122 (22 J/g) and 119° C. (20 J/g) and both had glass transition Tg of −27° C. ¹H NMR showed that sample B had a composition of 49.2 mole % 4G, 24.2 mole % 1.0 T, 25.4 mole % Suc, 1.05 mole % PTG 1800 and 0.1 mole % HMDI. Pressed films of samples A and B had Young's Modulus of 62 and 54 MPa, tensile strengths of 39 and 35 MPa, and elongations of 1060 and 977%.

Compared to those of Table 2, this example showed that there was little difference in the measured tensile properties before and after chain extension, and that an intrinsic viscosity of at least 1.0 dL/g leads to the best tensile properties.

### Examples 21-28

A series of copolyetheresters were synthesized from 1,4-butanediol, terephthalic acid, and various bio-based polyalkylene ether glycols as shown in Table 3. In Examples 27 and 28, hexamethylene diisocyanate was used to rapidly chain extend the polymers to higher molecular weights. Better tensile properties were obtained for the copolyetheresters containing the lower molecular weight bio-based poly(trimethylene ether)glycol, P3G 250, but the examples of Table 2 show that inclusion of succinic acid more consistently leads to the best tensile properties.

### Examples 29-34

A series of copolyetheresters were synthesized from 1,3-propanediol, terephthalic acid, and various bio-based polyalkylene ether glycols as shown in Table 4. In Example 34, hexamethylene diisocyanate was used to rapidly chain extend the polymers to higher molecular weights. The tensile properties were inferior to those copolyetheresters containing 1,4-butanediol.

### Comparative Example C

Films were pressed from samples of Ecoflex®, a commercial biodegradable copolyester based on 1,4-butanediol, terephthalic acid, and adipic acid, for comparison to the working and comparative examples as shown in Table 5. Tensile properties were also obtained at 2000%/min for all of the films.

Table 5 shows that copolyetheresters containing succinic acid have excellent tensile properties at strain rates of both 500%/min and 2000%/min that were similar to Comparative Examples A and C. The Elmendorf tear strengths were lower than the comparative examples, but those for the copolyetheresters containing PTG 1800 were still sufficient for typical biodegradable film applications.

TABLE 1

| Example | 4G | TPA | DMT | Seb | PAEG | | IV | Tg | Tm | Diol | T | Seb | PAEG | YM | TS | E |
|---|---|---|---|---|---|---|---|---|---|---|---|---|---|---|---|---|
| # | g | g | g | g | ID | g (wt %) | dL/g | ° C. | ° C. | mole % | mole % | mole % | mole % | MPa | Mpa | % |
| CEA | 68.1 | 34.9 | | 42.4 | — | — | 1.38 | −33 | 128 | 50.2 | 26.2 | 23.5 | 0.08 | 59 | 37 | 1080 |
| CEB | 68.1 | | 40.7 | 42.4 | — | — | 1.43 | −35 | 122 | 50.1 | 25.5 | 24.3 | 0.08 | 62 | 33 | 1031 |
| 1 | 60.7 | — | 33.9 | 41.4 | PTG 1800 | 9.6 | 0.92 | −45 | 115 | 49.6 | 24.0 | 25.7 | 0.70 | 35 | 25 | 1171 |
| 2 | 68.1 | — | 44.7 | 39.4 | PTG 1800 | 10.6 | 0.83 | −43 | 132 | 49.6 | 27.4 | 22.3 | 0.71 | 51 | 19 | 998 |
| 3 | 59.7 | 31.1 | — | 36.4 | PTG 1800 | 13.2 | 0.95 | −45 | 125 | 49.4 | 26.0 | 23.6 | 0.98 | 33 | 18 | 1236 |
| 4 | 55.2 | 29.6 | — | 34.7 | PTG 1800 | 17.6 | 0.78 | −50 | 122 | 49.2 | 25.2 | 24.3 | 1.3 | 37 | 14 | 1057 |
| 5 | 56.4 | | 38.8 | 34.4 | P3G 650 | 14.4 | 1.24 | −50 | 127 | 46.0 | 27.2 | 22.8 | 4.0 | 35 | 21 | 1247 |
| 6 | 62.6 | 33.2 | — | 37.3 | P3G 650 | 10.0 | 1.11 | −47 | 123 | 47.9 | 26.2 | 23.5 | 2.4 | 39 | 14 | 1111 |
| 7 | 63.1 | 37.3 | — | 32.9 | P3G 250 | 13.6 | 1.39 | −45 | 135 | 41.3 | 29.5 | 20.2 | 9.0 | 36 | 31 | 1174 |

TABLE 2

| Example | 4G | TPA | Suc | PAEG | | HMDI | IV | Tg | Tm | Diol | T | Suc | PAEG | YM | TS | E |
|---|---|---|---|---|---|---|---|---|---|---|---|---|---|---|---|---|
| # | g | g | g | ID | g (wt %) | g (wt %) | dL/g | ° C. | ° C. | mole % | mole % | mole % | mole % | MPa | Mpa | % |
| 9 | 70.4 | 36.7 | 25.1 | PTG 1800 | 15.6 | — | 0.82 | −24 | 137 | 49.4 | 27.1 | 22.5 | 1.0 | 59 | 29 | 898 |
| 10 | 71.1 | 33.4 | 27.9 | PTG 1800 | 15.8 | — | 1.17 | −29 | 122 | 50.3 | 23.8 | 24.8 | 1.02 | 56 | 37 | 969 |
| 11 | 71.1 | 33.4 | 27.9 | PTG 1800 | 15.8 | 0.4 | 1.20 | −26 | 118 | 49.5 | 24.1 | 25.3 | 1.0 | 53 | 40 | 951 |
| 12 | 71.1 | 33.4 | 27.9 | PTG 1800 | 15.8 | 0.19 | 1.26 | −27 | 121 | 49.2 | 24.4 | 25.3 | 1.0 | 52 | 36 | 894 |
| 13 | 67.5 | 37.4 | 24.6 | P3G 650 | 16.9 | — | 1.16 | −32 | 130 | 47.6 | 26.5 | 22.9 | 3.0 | 52 | 29 | 1054 |
| 14 | 72.2 | 38.4 | 25.2 | P3G 650 | 14.4 | — | 1.48 | −30 | 134 | 46.6 | 27.3 | 23.5 | 2.6 | 52 | 39 | 1050 |
| 15 | 70.7 | 34.8 | 26.8 | P3G 650 | 17.0 | — | 1.48 | −34 | 120 | 47.4 | 25.6 | 23.8 | 3.2 | 57 | 36 | 1093 |
| 16 | 64.0 | 43.3 | 22.3 | P3G 250 | 15.7 | — | 0.84 | −23 | 141 | 44.1 | 29.8 | 19.8 | 6.3 | 112 | 18 | 654 |
| 17 | 74.0 | 39.3 | 25.8 | P3G 250 | 15.9 | — | 1.36 | −22 | 126 | 44.8 | 27.0 | 22.5 | 5.7 | 72 | 40 | 1003 |
| 18 | 71.5 | 39.5 | 23.9 | P3G 250 | 19.8 | — | 1.58 | −25 | 124 | 42.0 | 28.9 | 20.4 | 8.7 | 68 | 36 | 959 |
| 19 | 63.3 | 44.0 | 14.7 | P3G 250 | 31.2 | — | 1.33 | −26 | 143 | 37.5 | 34.9 | 14.8 | 12.8 | 97 | 31 | 797 |

TABLE 3

| Example | 4G | TPA | PAEG | | HMDI | IV | Tg | Tm | Diol | T | PAEG | YM | TS | E |
|---|---|---|---|---|---|---|---|---|---|---|---|---|---|---|
| # | g | g | ID | g (wt %) | g (wt %) | dL/g | ° C. | ° C. | mole % | mole % | mole % | MPa | Mpa | % |
| 21 | 32.4 | 33.2 | P3G 650 | 64.8 | — | 1.18 | −59 | 140 | 25.1 | 50.1 | 24.8 | 26 | 8 | 516 |
| 22 | 29.1 | 29.8 | P3G 650 | 70.0 | — | 1.25 | −59 | 130 | 20.8 | 50.1 | 29.1 | 17 | 7 | 639 |
| 23 | 51.1 | 52.4 | P3G 250 | 47.3 | — | 1.28 | −28 | 144 | 23.2 | 50.0 | 26.8 | 100 | 22 | 709 |
| 24 | 50.1 | 51.3 | P3G 250 | 49.4 | — | 1.29 | −28 | 137 | 21.3 | 50.1 | 28.6 | 91 | 20 | 712 |
| 25 | 50.1 | 51.3 | P3G 250 | 49.4 | — | 1.24 | −29 | 142 | 22.4 | 49.9 | 27.7 | 102 | 21 | 700 |
| 26 | 55.0 | 50.3 | P3G 250 | 51.5 | — | 1.32 | −26 | 176 | 27.5 | 50.1 | 22.4 | 180 | 37 | 625 |
| 27 | 55.0 | 50.3 | P3G 250 | 51.5 | 0.25 | 1.59 | −28 | 154 | 23.3 | 50.0 | 26.5 | 109 | 38 | 761 |
| 28 | 53.1 | 48.9 | P3G 250 | 54.4 | 0.75 | 1.53 | −29 | 138 | 19.3 | 49.7 | 30.4 | 75 | 28 | 789 |

TABLE 4

| Example | 3G | TPA | DMT | PAEG | | HMDI | IV | Tg | Tm | Diol | T | PAEG | YM | TS | E |
|---|---|---|---|---|---|---|---|---|---|---|---|---|---|---|---|
| # | g | g | g | ID | g (wt %) | g (wt %) | dL/g | ° C. | ° C. | mole % | mole % | mole % | MPa | Mpa | % |
| 29 | 27.7 | 33.6 | — | P3G 650 | 65.8 | — | 1.54 | −57 | 126 | 24.0 | 49.9 | 26.1 | 24 | 9 | 717 |
| 30 | 24.8 | 30.1 | — | P3G 650 | 70.7 | — | 1.45 | −58 | 96 | 19.5 | 50.0 | 30.5 | 14 | 6 | 748 |
| 31 | 45.4 | — | 64.5 | P3G 250 | 44.8 | — | 1.21 | −22 | 153 | 25.2 | 49.8 | 25.0 | 142 | 14 | 301 |
| 32 | 43.0 | 52.1 | — | P3G 250 | 50.2 | — | 1.37 | −25 | 136 | 20.8 | 49.8 | 29.4 | 105 | 18 | 672 |
| 33 | 47.1 | 50.1 | — | P3G 250 | 52.2 | — | 1.28 | −23 | 107 | 17.5 | 49.6 | 32.9 | 74 | 8 | 372 |
| 34 | 47.6 | 52.0 | — | P3G 250 | 50.1 | 0.2 | 1.64 | −25 | 142 | 21.5 | 50.0 | 28.3 | 101 | 24 | 744 |

TABLE 5

| Example | IV | YM, MPa | | TS, MPa | | E, % | | Elm Tear |
|---|---|---|---|---|---|---|---|---|
| # | dL/g | 500%/min | 2000%/min | 500%/min | 2000%/min | 500%/min | 2000%/min | g/mm |
| CEA | 1.38 | 59 | 64 | 37 | 35 | 1080 | 1020 | 17,000 |
| CEC | 1.3 | 71 | 85 | 36 | 39 | 930 | 963 | 13,500 |
| 10 | 1.17 | 56 | 56 | 37 | 35 | 969 | 1019 | 9800 |
| 12 | 1.26 | 52 | 59 | 36 | 40 | 894 | 955 | 9600 |
| 15 | 1.48 | 57 | 59 | 36 | 29 | 1093 | 1031 | 4800 |
| 20A | 1.05 | 62 | 60 | 39 | 36 | 1060 | 1006 | — |
| 20B | 1.19 | 54 | 58 | 35 | 38 | 977 | 998 | — |

What is claimed is:

1. An aliphatic-aromatic copolyetherester consisting essentially of:
I. a dicarboxylic acid component consisting essentially of, based on 100 mole percent total dicarboxylic acid component:
a. about 100 to about 40 mole percent of a terephthalic acid component;
b. about 0 to about 60 mole percent of a linear aliphatic dicarboxylic acid component; and
c. optionally about 2 to about 60 mole percent of a non-linear dicarboxylic acid component;
II. a glycol component consisting essentially of, based on 100 mole percent total glycol component:
a. about 99.5 to about 30 mole percent of a linear glycol component; and
b. about 0.5 to about 70 mole percent of a polyalkylene ether glycol component.

2. The aliphatic-aromatic copolyetherester of claim 1 wherein the copolyester is semicrystalline.

3. The aliphatic-aromatic copolyetherester of claim 1 wherein the copolyester is biodegradable as defined according to EN 13432.

4. The aliphatic-aromatic copolyetherester of claim 1 wherein the linear dicarboxylic acid component is selected from the group consisting of succinic acid, glutaric acid, azelaic acid, sebacic acid, and brassylic acid.

5. The aliphatic-aromatic copolyetherester of claim 1 wherein the linear dicarboxylic acid component is succinic acid.

6. The aliphatic-aromatic copolyetherester of claim 1 wherein the linear glycol component is selected from the group consisting of 1,3-propanediol and 1,4-butanediol.

7. The aliphatic-aromatic copolyetherester of claim 1 wherein the polyalkylene ether glycol component has a molecular weight in the range of about 100 to 4000 daltons.

8. The aliphatic-aromatic copolyetherester of claim 1 wherein the polyalkylene ether glycol component is selected from the group consisting of poly(trimethylene ether) glycol and poly(tetramethylene ether) glycol.

9. The aliphatic-aromatic copolyetherester of claim 1 wherein the optional non-linear dicarboxylic acid component is selected from the group consisting of fatty acid dimer, hydrogenated fatty acid dimer, 1,2-cyclohexane dicarboxylic acid, (±)-camphoric acid, phthalic anhydride, and phthalic acid.

10. The aliphatic-aromatic copolyether ester of claim 1 wherein the dicarboxylic acid component consists essentially of:
a. about 70 to about 40 mole percent of the terephthalic acid component;
b. about 30 to about 60 mole percent of the linear aliphatic dicarboxylic acid component; and
c. optionally about 2 to about 60 mole percent of the non-linear dicarboxylic acid component;
wherein the glycol component consists essentially of:
a. about 99.5 to about 70 mole percent of the linear glycol component; and
b. about 0.5 to about 30 mole percent of the polyalkylene ether glycol component.

11. The aliphatic-aromatic copolyetherester of claim 1 wherein the dicarboxylic acid component consists essentially of:
a. about 56 to about 46 mole percent of the terephthalic acid component; and
b. about 44 to about 54 mole percent of the linear aliphatic dicarboxylic acid component;
wherein the glycol component consists essentially of:
a. about 99 to about 96 mole percent of the linear glycol component; and
b. about 1 to about 4 mole percent of the polyalkylene ether glycol component having a molecular weight in the range of about 1000 to about 2000 daltons.

12. The aliphatic-aromatic copolyetherester of claim 1 wherein the dicarboxylic acid component consists essentially of about 100 mole percent of the terephthalic acid component; and
wherein the glycol component consists essentially of:
a. about 50 to about 30 mole percent of the linear glycol component; and
b. about 50 to about 70 mole percent of the polyalkylene ether glycol component having a molecular weight in the range of about 100 to about 1000 daltons.

13. The aliphatic-aromatic copolyetherester of claim 1 wherein the dicarboxylic acid component consists essentially of about 100 mole percent of the terephthalic acid component; and
wherein the glycol component consists essentially of:
c. about 44 to about 35 mole percent of the linear glycol component; and
d. about 56 to about 65 mole percent of the polyalkylene ether glycol component having a molecular weight in the range of about 200 to about 400 daltons.

14. A blend comprising the aliphatic-aromatic copolyetherester of claim 1 and at least one other polymeric material.

15. The blend of claim 14 wherein the other polymeric material is selected from the group consisting of a naturally derived polymer, starch, and poly(lactic acid).

16. A shaped article comprising the aliphatic-aromatic copolyetherester of claim 1.

17. A shaped article comprising the blend of claim 14.

18. A film comprising the aliphatic-aromatic copolyetherester of claim 1.

19. A film comprising the blend of claim 14.

20. The film of claim 18 with tear strength greater than about 4000 g/mm according to ASTM D1922.
